(19) United States
(12) Patent Application Publication
(10) Pub. No.: US 2025/0003429 A1
(43) Pub. Date: Jan. 2, 2025

(54) PRESSURE SENSING DEVICE

(71) Applicant: ENTEGRIS, INC., Billerica, MA (US)

(72) Inventors: Thines Kumar Perumal, Singapore (SG); Aravind Vasanthakumar, Singapore (SG); Subhash Guddati, Singapore (SG); Montray Leavy, Singapore (SG); Sanado Barolli, Bethlehem, CT (US); Edward E. Jones, Woodbury, CT (US)

(21) Appl. No.: 18/708,576

(22) PCT Filed: Nov. 29, 2022
(86) PCT No.: PCT/US2022/051245

§ 371 Date: May 8, 2024

Related U.S. Application Data
(60) Provisional application No. 63/284,899, filed on Dec. 1, 2021.

(51) Int. Cl. F15B 3/00

(52) U.S. Cl. CPC F15B 3/00

(57) ABSTRACT

A high pressure fluid storage system with at least one pressure sensing device (PSD) which can perform the function of a pressure regulator device. The PSD can be manufactured via an additive manufacturing process to include a first and a second single unitary constructions, wherein the housing body and the internal pressure regulating mechanism are made together during the process. The PSD can be made without any welded components or bellows.

### FIELD

The present disclosure relates to the field of vacuum actuated cylinders (VACs) and subatmospheric pressure gas delivery systems with pressure regulated valves.

### BACKGROUND

Subatmospheric pressure delivery systems, such as VACs, can use a pressure sensing device to regulate opening and closing of valves.

### SUMMARY

A traditional pressure sensing assembly (TPSA) generally includes more than 10 components, which require multiple steps in assembling and welding of the components. In some TPSAs, there can be 17 or more separate components, made of different materials. Assembly of these various components and welding of those components to produce the TPSA can lead to inconsistent performances, failures due to poor manufacturing processes and quality control, or both. Further, these multiple components of the TPSA are often manufactured at different locations or by different manufacturers, and the varying tolerances amongst them can lead to the final assembled TPSA having inconsistent quality and performances. Inconsistent performances can include, for example, gas spikes, gas pressure oscillations, or both. Failures of TPSAs are generally detected during operation. Identifying the specific reasons for such failures in assembled TPSAs is difficult because there can be many different components which can be the cause of the failure.

In some embodiments, a device which can replace these TPSA is disclosed herein.

Some embodiments of the present disclosure relate to a pressure sensing device (PSD). In some embodiments, the PSD is a VAC regulator device. The PSD can have better consistency in performance than the TPSA, and reduce gas spikes, gas pressure oscillations, or both.

Some embodiments of the present disclosure relate to a VAC having a VAC regulator device, wherein the VAC regulator device includes an embodiment of the PSD. Some embodiments of the present disclosure relate to a VAC having one or more VAC regulator devices, wherein at least one of the VAC regulator devices includes an embodiment of the PSD.

Some embodiments of the present disclosure relate to a PSD which does not have any of the manufacturing defects that can be present in the TPSA.

Some embodiments of the present disclosure relate to a PSD which does not have any welded components.

Some embodiments of the present disclosure relate to a PSD which does not have any bellows.

Some embodiments of the present disclosure relate to a PSD which does not have any flexible diaphragms.

Some embodiments of the present disclosure relate to a PSD can be manufactured via additive manufacturing process(es) (e.g., 3D printing).

In some embodiments, the PSD is made from a material which is capable of additive manufacturing. In some embodiments, the material is a polymer. In some embodiments, the material is a metal, such as for example, stainless steel. In some embodiments, the material is a composite material, which is a combination of materials. In some embodiments, the PSD is made from different materials, wherein some parts are made from a first material, and other parts are made from a second material, and so on. For example, the housing, the movable plate with a slip-joint, and the O-rings, which make up some embodiments of the PSD can be made of materials that are different from each other. In some embodiments, the housing, and the movable plate with the slip-joint can be made from the same material. In some embodiments, the O-rings can be made from a different material from the housing, the movable plate, and/or the slip-joint.

In some embodiments, the PSD includes a housing and a pressure reducing mechanism. In some embodiments, the housing is a unitary construction without any welding. In some embodiments, the pressure reducing mechanism (e.g., the movable plate with the slip-joint) is a unitary construction without any welding. In some embodiments, the housing and the pressure reducing mechanism are formed together via additive manufacturing such that the pressure reducing mechanism is formed to be contained within the housing made of a single unitary body. During this manufacturing process, for example, O-rings can also be introduced via additive manufacturing or by obtaining the O-rings and placing them at appropriate locations and times.

In some embodiments, a pressure reducing mechanism includes, at least, a movable portion with a slip-joint, which is a component contained within an inner chamber defined by the structure of the housing, and the slip-joint is configured to move the movable portion (e.g., a movable plate or face plate) relative to an internal non-moving structure of the housing. The movement via the slip-joint opens or closes the valve which is located near the inlet.

As used herein, the term “fluid” includes gas.

In some embodiments, there are no welds between the movable portion and the housing.

In some embodiments, a device comprising a first single unitary body, which includes a housing, wherein the housing includes an inlet, and an outlet; and a second single unitary body, which includes a pressure reducing mechanism, which is contained within the housing, and is disposed between the inlet and the outlet, wherein the pressure reducing mechanism includes a movable portion connected to a valve, wherein the pressure reducing mechanism is configured to receive a fluid having an first pressure which enters via the inlet, direct a flow of the fluid towards the outlet at a second pressure.

In some embodiments of the device, the pressure reducing mechanism further comprises a stem, wherein the valve includes a poppet valve, wherein a first end of the stem is connected to the movable portion, a second end of the stem is connected to the poppet valve, wherein the pressure reducing mechanism operates such that the poppet valve is in an open state when the movable portion is moved towards the inlet, and the poppet valve is in a closed state when the movable portion is at rest or is moved towards the outlet.

In some embodiments of the device, the housing and the pressure reducing mechanism does not have any welds or welded components.

In some embodiments of the device, any of the single unitary body described herein is made of a metal. In some embodiments of the device, the metal includes a stainless steel.

In some embodiments of the device, the single unitary body further comprises a second pressure reducing mechanism, which is contained within the housing, and is disposed between the pressure reducing mechanism and the outlet, and wherein the pressure reducing mechanism is configured to receive the fluid from the pressure reducing mechanism having the second pressure, and then direct the flow of the fluid towards the outlet at a third pressure.

In some embodiments of the device, the first pressure is higher than subatmospheric pressure.

In some embodiments of the device, the second pressure is subatmospheric pressure.

In some embodiments of the device, the second pressure is lower than the first pressure.

In some embodiments, a device comprises a first single unitary body, which includes a housing, wherein the housing includes an inlet, and an outlet; and a second single unitary body, which includes a pressure reducing mechanism, which is contained within the housing, and is disposed between the inlet and the outlet, wherein the pressure reducing mechanism includes a movable portion connected to a valve, wherein the pressure reducing mechanism is configured to receive a fluid having an first pressure which enters via the inlet, direct a flow of the fluid towards the outlet at a second pressure.

In some embodiments of the device, the pressure reducing mechanism further comprises a stem, wherein the valve includes a poppet valve, wherein a first end of the stem is connected to one side of the movable portion, a second end of the stem is connected to the poppet valve, wherein the pressure reducing mechanism operates such that the poppet valve is in an open state when the movable portion moves towards the inlet, and the poppet valve is in a closed state when the movable portion is at rest or moves towards the outlet.

In some embodiments of the device, the housing and the pressure reducing mechanism does not have any welds or welded components.

In some embodiments of the device, the first single unitary body is made of a metal.

In some embodiments of the device, the metal includes a stainless steel.

In some embodiments of the device, the second single unitary body is made of a metal.

In some embodiments of the device, the metal includes a stainless steel.

In some embodiments of the device, the pressure reducing mechanism does not include a bellows, a diaphragm, or both.

In some embodiments, the device further comprises a third single unitary body, which includes a second pressure reducing mechanism, which is contained within the housing, and is disposed between the pressure reducing mechanism and the outlet, wherein the second pressure reducing mechanism is configured to receive the fluid from the pressure reducing mechanism having the second pressure, and then direct the flow of the fluid towards the outlet at a third pressure.

In some embodiments of the device, the first pressure is higher than subatmospheric pressure.

In some embodiments of the device, the second pressure is subatmospheric pressure.

In some embodiments of the device, the second pressure is lower than the first pressure.

In some embodiments, a fluid supply system comprises a container body, which defines an internal cavity for storing a fluid at a first pressure; and a pressure regulator device, which is disposed in the internal cavity. The pressure regulator device includes a first single unitary body, which includes a housing, wherein the housing includes an inlet, and an outlet; and a second single unitary body, which includes a pressure reducing mechanism, which is contained within the housing, and is disposed between the inlet and the outlet, wherein the pressure reducing mechanism includes a movable portion connected to a valve, wherein the pressure reducing mechanism is configured to receive a fluid having an first pressure which enters via the inlet, direct a flow of the fluid towards the outlet at a second pressure.

In some embodiments of the fluid supply system, the pressure reducing mechanism further comprises a stem, wherein the valve includes a poppet valve, wherein a first end of the stem is connected to one side of the movable portion, a second end of the stem is connected to the poppet valve, wherein the pressure reducing mechanism operates such that the poppet valve is in an open state when the movable portion moves towards the inlet, and the poppet valve is in a closed state when the movable portion is at rest or moves towards the outlet.

In some embodiments, the fluid supply system further comprises a second pressure regulator device, wherein an inlet of the second pressure regulator device is connected to the outlet of the pressure regulator device.

In some embodiments, the fluid supply system further comprises a filter device connected to the inlet of the pressure regulator device.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a schematic diagram of a non-limiting embodiment a subatmospheric pressure delivery system having one or more PSD described herein.

FIG. 2 depicts a schematic side view of a non-limiting embodiment of the PSD described herein.

FIG. 3 depicts a schematic cross-sectional view of the PSD of FIG. 2.

FIG. 4 depicts a perspective view of a non-limiting embodiment of the PSD described herein.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural portion being disposed between two other structural elements can be:
disposed directly between both of the two other structural elements such that the particular structural portion is in direct contact with both of the two other structural elements;
disposed directly next to only one of the two other structural elements such that the particular structural portion is in direct contact with only one of the two other structural elements;
disposed indirectly next to only one of the two other structural elements such that the particular structural portion is not in direct contact with only one of the two other structural elements, and there is another element which juxtaposes the particular structural portion and the one of the two other structural elements;
disposed indirectly between both of the two other structural elements such that the particular structural portion is not in direct contact with both of the two other structural elements, and other features can be disposed therebetween; or
any combination(s) thereof.

As used herein, the term “single unitary body” and “unitary body” means an article which has been formed or constructed unitarily via an additive manufacturing process(es) (e.g., 3D printing).

As used herein, the term “unitary device” means a device made via an additive manufacturing process(es) (e.g., 3D printing). As such, the “unitary device” can have one or more “single unitary body.” That is, a “unitary device” can have several parts that move with respect to each other, such as, for example, a component contained within a container housing, where in said component is movably in contact with said container housing (e.g., via a hinge or a slip-joint). The term “unitary device” does not necessarily exclude other non-additively manufactured component(s) being a part of it. Generally, a “unitary device” does not include any welded components or welded or glued seams. Examples of materials for additive manufacturing processes includes polymers, metals, stainless steel, composite materials, or combinations thereof.

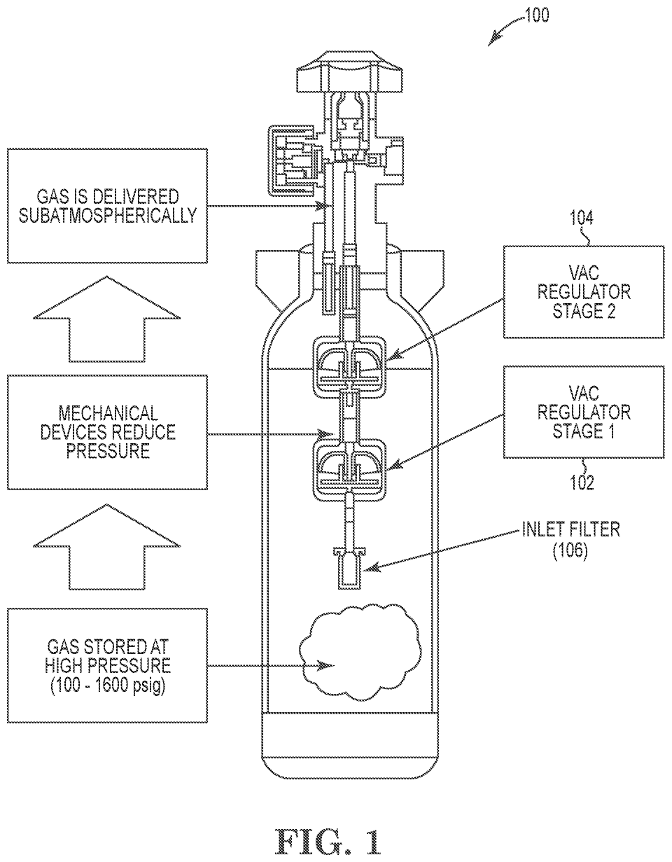

FIG. 1 depicts a schematic diagram of a non-limiting embodiment a subatmospheric pressure delivery system 100 having mechanical devices 102, 104 configured to reduce pressure of a fluid so that the output of the fluid is at a subatmospheric pressure. The mechanical devices 102, 104 include a first VAC regulator 102 at stage 1 and a second VAC regulator 104 at stage 2. Each of the VAC regulators 102, 104 can be or include a PSD described herein. The first VAC regulator 102 is connected to an inlet filter device 106, and also to the second VAC regulator 104. The system 100 shown in FIG. 1 has the inlet filter device 106, the first VAC regulator 102, and the second VAC regulator 104 in line as a serial connection. Thus, a fluid which is stored at a high pressure, such as for example, 100-1600 psig, flows into the inlet filter 106, and then passes through the first VAC regulator 102, and the second VAC regulator 104, wherein the VAC regulators 102, 104 reduce the pressure of the fluid, and the fluid can be delivered out of the system 100 at subatmospheric pressure.

In some embodiments, each of the mechanical devices 102, 104 is a unitary device. Accordingly, the two unitary devices 102, 104 can be joined together as depicted in the exemplary embodiment shown in FIG. 1.

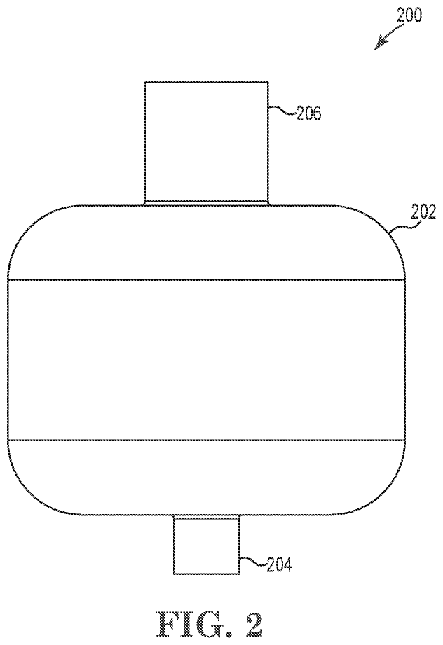

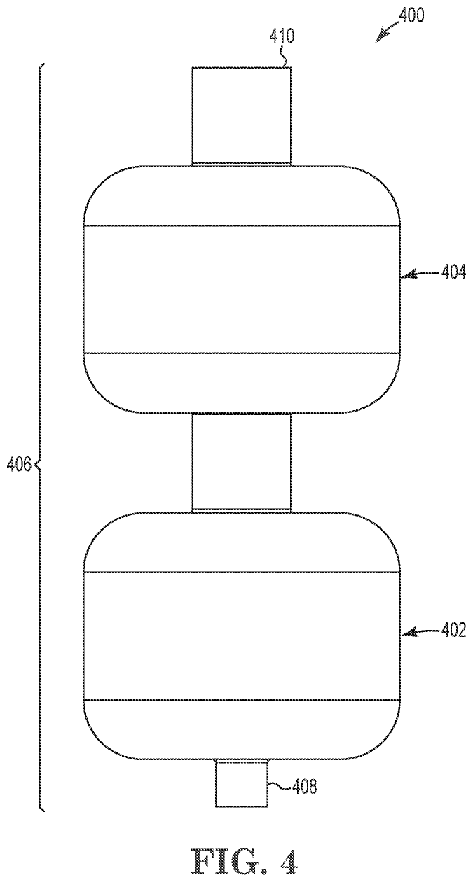

FIG. 2 shows a side view of a non-limiting embodiment of the PSD 200. The PSD 200 has a housing 202 with an inlet 204 and an outlet 206. It will be understood that, according to some embodiments, two or more PSDs can be formed together in a single housing (e.g., see FIGS. 1 and 4).

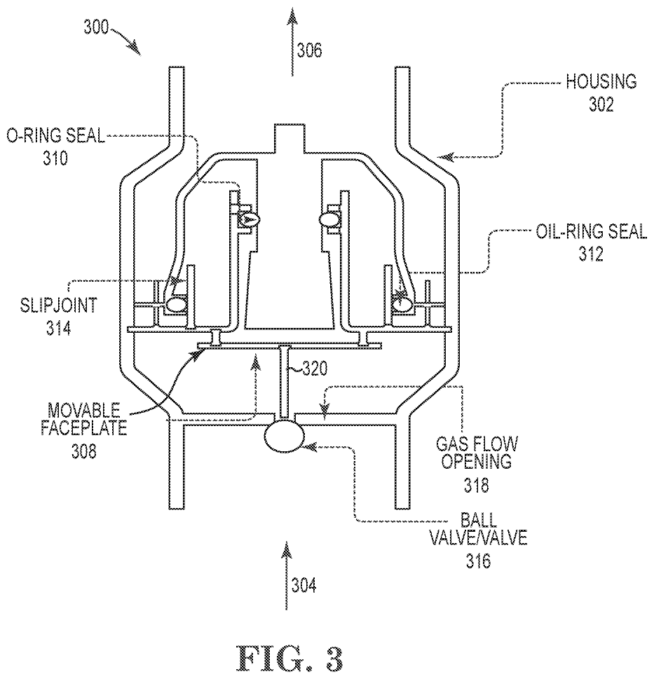

FIG. 3 shows a schematic side view of an embodiment of a PSD 300. The PSD 300 includes a housing 302 which is a single unitary body construction. The housing 302 includes an inlet 304 and an outlet 306. The PSD 300 includes a second unitary body construction which includes a movable portion (e.g., movable faceplate) 308 which is connected to an internal chamber of the housing 302 via a set of O-ring seals 310, 312. The movable faceplate 308 is also connected to a slip-joint 314 which is configured to slip or slide along portions of inner surfaces of the inner chamber of the housing 302. The movable faceplate 308 is connected to a valve 316 via a stem 320. That is, one end of the stem 320 is connected to the valve 316 which is configured to interact with a hole (e.g., fluid flow opening) 318 as the movable faceplate 308 moves with respect to the housing 302. The valve 316, which can be or include a poppet valve, has an open state when the movable faceplate 308 is moved closer towards the inlet 304. The valve 316 has a closed state when the movable faceplate 308 is moved closer towards the outlet 306. The movable faceplate 308, the stem 320, the valve 316, and the slip-joint 314 can be all part of a single unitary body which makes up the pressure reducing mechanism. Accordingly, the PSD 300 can be manufactured via an additive process (i.e., 3D printing), whereas both the housing (a first single unitary body) and the pressure reducing mechanism (a second single unitary body) are formed together. Thus, the PSD 300 does not require any welding of various parts or components.

In some embodiments, the mechanical devices (102, 104 shown in FIG. 1) together is a unitary device, PSD 400. As shown in FIG. 4, in such embodiments of the PSD 400, there are two portions 402, 404 (internal structure not shown, but are similar to those shown in, for example, FIG. 3) contained serially in a single housing 406, where in the housing 406 and the two pressure portions 402, 404 are formed from a single unitary body. Such single unitary body can be made via, for example, additive manufacturing process. Accordingly, the PSD 400 does not require welding or assembling after the manufacturing process. Thus, the PSD 400 does not include any welds. In some embodiments, each of the portions 402, 404 include independently operating parts. Thus, a fluid can enter via the inlet 408, travel through the internal compartment (e.g., as shown in FIG. and described herein), and then travel through the internal compartment (e.g., as shown in FIG. 3 and described herein) of the portion 404, and then travel out via the outlet 410. While FIG. 4 shows two portions 402, 404, it will be understood that, in some embodiments of the PSD, there can be more than two portions in serial, in parallel, or any combinations thereof.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A device comprising:
a first single unitary body, which includes:
a housing,
wherein the housing includes:
an inlet, and
an outlet; and
a second single unitary body, which includes:
a pressure reducing mechanism, which is contained within the housing, and is disposed between the inlet and the outlet,
wherein the pressure reducing mechanism includes a movable portion connected to a valve,
wherein the pressure reducing mechanism is configured to receive a fluid having a first pressure which enters via the inlet, direct a flow of the fluid towards the outlet at a second pressure.

2. The device of claim 2, wherein the pressure reducing mechanism further comprises a stem,
wherein the valve includes a poppet valve,
wherein a first end of the stem is connected to one side of the movable portion,
a second end of the stem is connected to the poppet valve,
wherein the pressure reducing mechanism operates such that the poppet valve is in an open state when the movable portion moves towards the inlet, and the poppet valve is in a closed state when the movable portion is at rest or moves towards the outlet.

3. The device according to claim 1, wherein the housing and the pressure reducing mechanism does not have any welds or welded components.

4. The device according to claim 1, wherein the first single unitary body is made of a metal.

5. The device of claim 4, wherein the metal includes a stainless steel.

6. The device according to claim 1, wherein the second single unitary body is made of a metal.

7. The device of claim 6, wherein the metal includes a stainless steel.

8. The device according to claim 1, wherein the pressure reducing mechanism does not include a bellows, a diaphragm, or both.

9. The device according to claim 1, further comprising:
a third single unitary body, which includes:
a second pressure reducing mechanism, which is contained within the housing,
and is disposed between the pressure reducing mechanism and the outlet,
wherein the second pressure reducing mechanism is configured to receive the fluid from the pressure reducing mechanism having the second pressure, and
then direct the flow of the fluid towards the outlet at a third pressure.

10. The device according to claim 1, wherein the first pressure is higher than subatmospheric pressure.

11. The device according to claim 1, wherein the second pressure is subatmospheric pressure.

12. The device according to claim 1, wherein the second pressure is lower than the first pressure.

13. A fluid supply system comprising:
a container body, which defines an internal cavity for storing a fluid at a first pressure; and
a pressure regulator device, which is disposed in the internal cavity, and includes:
a first single unitary body, which includes:
a housing,
wherein the housing includes:
an inlet, and
an outlet; and
a second single unitary body, which includes:
a pressure reducing mechanism, which is contained within the housing,
and is disposed between the inlet and the outlet,
wherein the pressure reducing mechanism includes a movable portion connected to a valve,
wherein the pressure reducing mechanism is configured to receive a fluid having a first pressure which enters via the inlet, direct a flow of the fluid towards the outlet at a second pressure.

14. The fluid supply system of claim 13, wherein the pressure reducing mechanism further comprises a stem,
wherein the valve includes a poppet valve,
wherein a first end of the stem is connected to one side of the movable portion,
a second end of the stem is connected to the poppet valve,
wherein the pressure reducing mechanism operates such that the poppet valve is in an open state when the movable portion moves towards the inlet, and the poppet valve is in a closed state when the movable portion is at rest or moves towards the outlet.

15. The fluid supply system according to claim 13, further comprising a second pressure regulator device, wherein an inlet of the second pressure regulator device is connected to the outlet of the pressure regulator device.

16. The fluid supply system according to claim 13, further comprising a filter device connected to the inlet of the pressure regulator device.
